(19) United States
(12) Patent Application Publication
(10) Pub. No.: US 2010/0293009 A1
(43) Pub. Date: Nov. 18, 2010

(54) System and method for protecting and issuing an investment security

(76) Inventors: Michael Alexander Gorun, Montclair, NJ (US); Justin Andrew Weinberg, Seekonk, MA (US)

Correspondence Address: Christopher J. Capelli, Esq., 2 Suzanne Lane, Chappaqua, NY, 10514, US

(21) Appl. No.: 12/454,329

(22) Filed: May 15, 2009

(51) Int. Cl. G06Q 40/00

(52) U.S. Cl. 705/4

(57) ABSTRACT

A system for providing protected securities over a period of time against a change in value. The system including an investment system electronically coupled to a security provider system operative to issue securities and to a insurance provider system operative to issue derivative insurance instruments that protect securities issued from the security provider over a prescribed period of time against a negative change in value. The investment system is operative to acquire the derivative insurance instruments from the insurance provider system and the securities from the security provider system so as to package the derivative insurance instruments with the acquired securities thereby providing protected securities that have their value protected over a period of time.

### FIELD OF THE INVENTION

The instant invention relates to the field of investment securities. More particularly, the invention relates to an electronic system and method for protecting the value of an Exchange Traded Fund or security against negative price fluxation over a period of time.

### BACKGROUND OF THE INVENTION

Modern investors may invest in numerous types of securities such as stocks, mutual funds, options, commodities, futures, derivatives, stock index futures, certificates of deposit, exchange traded funds, or bonds. Commonly, the underlying purpose by the investor for purchasing a security is to achieve short-term or long-term appreciation in the price or value of the security.

Securities or assets, when first purchased have an initial purchase price or basis. It is the goal of the investor to maximize the return on his/her investment by selecting assets or securities that either increase in value or do not allow their principal to erode or decline in value over a period of time. However, due to the unpredictable and volatile nature of securities, this is often difficult to achieve resulting in lost value of the purchased security. While this situation is almost always disadvantageous for an investor, it is especially disadvantageous when the security was purchased for critical investment purposes such as retirement, school tuition, a home purchase or a like longtime goal Not all securities are alike with some carrying more risk for price volatility than others.

A new class of security that is gaining more popularity with the investment community is the Exchange Traded Fund (ETF).

An ETF is an investment security that is similar to stocks, except that the shares of a given ETF represent an index of stocks, other securities or other investments rather than a single company. Similar to mutual funds, ETFs provide an investor with various types of diversity of risk or exposure within a single fund. However, ETFs provide the added benefit of lower expenses, greater transparency of holdings, better tax efficiency, and flexibility. For example, unlike mutual funds, whose shares may only be bought at the end of the day based on that day's closing price or net asset value as of 4:00 pm on any given day, ETF shares may be purchased intraday, at any time during the trading day, in the same way stocks are traded. Examples of ETFs are the Standard & Poor's Depository Receipt (SPDR), otherwise known as a “spider”, that trades as a stock on the American Stock Exchange and is an index of, or otherwise represents, the S&P 500; Diamonds (DIA) that trades as a stock on the American Stock Exchange and is an index of, or otherwise represents, the thirty stocks in the Dow Jones Industrial Average; Cubes (QQQQ) that trades as a stock on the NASDAQ and is an index of, or otherwise represents, the NASDAQ 100. While ETF offerings are typically equity dominated with few fixed income options, they encompass a wide variety of asset classes, including domestic and international equity indices and bond indices.

As set forth above, ETFs have been a growing investment vehicle, as shown by growing analyst coverage, media coverage, distribution (retail penetration and institutional hedging and arbitrage, with a growth of specialists), and global expansion.

ETFs have a number of advantages over traditional mutual funds. They are easily tradable, having intraday execution, liquidity, and can be exchanged for its components. They are low cost, tax efficient, and are fully transparent. ETFs appeal to both retail customers and institutional entities that may either buy, sell or sponsor and offer services related to ETFs. However, and like other investment securities, ETFs are not immune from volatility and price depreciation.

Therefore, investors may find it advantageous to protect the principal by preventing any loss that may occur in the purchase price or basis of their security, whether it be an ETF or otherwise. This is especially advantageous for the aforementioned long-term investor when the security was purchased for investment purposes such as retirement, school tuition, a home purchase or a like longtime goal.

In the past, if such a long-term investor could not, or did not want to assume the volatility risk associated with an ETF or like security, the investor would either have to purchase low-risk securities, which typically provided relatively lower returns, or would simply avoid purchasing a security altogether.

One way a long-term investor could try to mitigate the volatility risk associated with an ETF or like security is to purchase an option contract, such as a put contract. A Put contract gives the owner the right, but not the obligation, to sell a specified amount of an underlying security at a specified price (Strike Price) within a specified time. An investor pays a price (premium) for the right to sell those shares at the specific price at a specified time. If the investor does not sell the security, the investor loses the premium paid to purchase the put contract.

A put option is typically a financial contract between two parties, the seller (writer) and the buyer of the option. The buyer acquires a long position offering the right, but not the obligation, to sell the underlying instrument at an agreed upon strike price. If the buyer exercises the right granted by the option, the writer has the obligation to purchase the underlying instrument at the strike price, with the buyer paying the difference. In exchange for having this option, the buyer typically pays the writer a fee (e.g., the option premium).

The terms for a put exercise differ depending on an option style. A “European” put option allows the buyer to exercise the put option for a short period of time right before expiration, while an “American” put option may be exercised at any time before expiration. Due primarily to the difference in exercise dates, the premium for an American put option is typically more than that for a European put option.

In other words, a security investor, who purchases a put option to mitigate the volatility risk associated with a purchased security, desires to protect a long position in the security in the event there is price depreciation of the asset by having the right to exercise the put option.

However, such put contracts are complex, difficult to understand, date limited, and expensive. These option contracts are only available for a limited number of securities, and cannot be purchased for other retirement focused assets such as mutual funds, bonds or a portfolio of securities. Moreover, European options, typically the least expensive of the most commonly traded option types, are usually not available for individual investors to purchase. Therefore, it is typically not possible for an investor to provide long-term insurance against price volatility for purchased securities through the purchase of “off the shelf” put options.

Thus, there is a strong need to provide an ETF or like security for a long-term investor that is structured to mitigate price depreciation on securities that are commonly held in investment portfolios for long-term investment purposes.

### SUMMARY OF THE INVENTION

An embodiment of the present invention includes a method for creating and issuing an insured security over a period of time. The method includes the steps of providing a security investment system for acquiring securities and subsequently creating and packaging the acquired securities with derivative products to provide an insured security which value is protected over a period of time.

A predetermined amount of shares of insured securities are acquired from the security investment system by the investor with each share being of a predetermined value and maturity date. This new customized asset is acquired from the investment system.

The OTC derivative products pertinent to the acquired security are exercised if the shares of the acquired securities have a value less than the price of the acquired securities at the date of initial purchase or a protected price at the date of purchase at the maturity date of the insured security wherein the exercised OTC derivative products have a value preferably equal to the difference in value of the securities between the exercised value and the predetermined value.

### BRIEF DESCRIPTION OF THE DRAWINGS

The objects and features of the invention may be understood with reference to the following detailed description of an illustrative embodiment of the invention taken together with the accompanying drawing in which:

FIG. 1 is a system diagram depicting an illustrated embodiment of the present invention; and

FIG. 2 is a flowchart diagram illustrating a method for protecting an acquired security over a period of time in accordance with the illustrated embodiment of FIG. 1.

### DETAILED DESCRIPTION

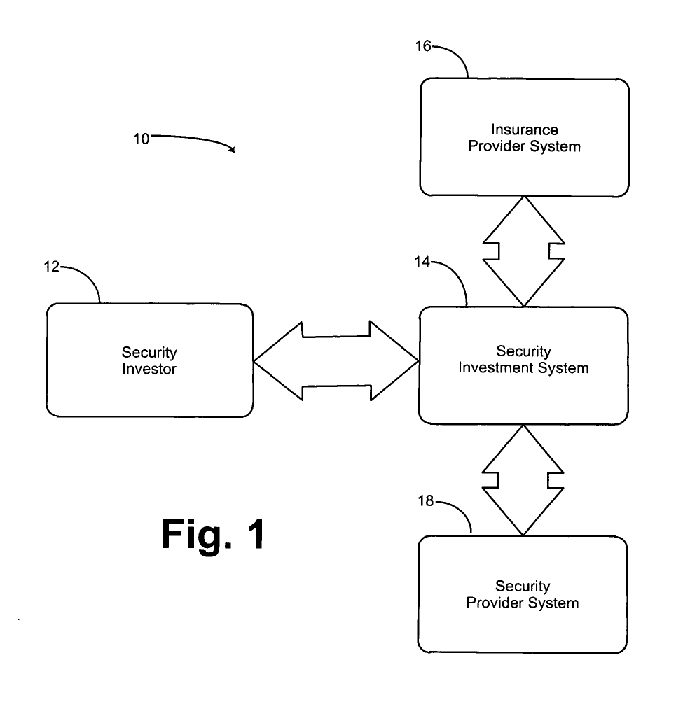

Turning now descriptively to the drawings, in which similar reference characters denote similar elements throughout the several views, FIG. 1 depicts a block diagram of the system components of the illustrated embodiment of the present invention system and method for protecting a security, generally indicated by reference numeral 10.

System 10 of an illustrated embodiment of the invention depicts a security investor 12 interacting with an investment system 14. It is to be appreciated that reference to a security investor 12 in the illustrated embodiment of the invention is to be understood to include, but not limited thereto, an individual investor, a fund investor, an institutional investor or the like. Security investor 12 may manually, or electronically (preferably through computer hardware and software) interact with investment system 14, preferably for acquiring and exercising securities as will be described in detail below.

Examples of securities that may be obtained, acquired, or purchased from security provider system 18 are stocks, bonds, mutual funds, options, commodities, futures, derivatives, stock index futures, total return swaps, certificates of deposit, and exchange traded funds (ETFs). For ease of description purposes, reference hereinafter to a security will be made in regards to exchange traded funds (ETF), but it is to be understood that the illustrated embodiment of the invention is not to be limited to an ETF, but rather may encompass any aforementioned security type or like product. For instance, one such type of security is a swap. Swap derivative products are a type of derivative in which two counterparties agree to exchange one stream of cash flow against another stream. These streams are commonly called the legs of the swap. The cash flows are calculated over a notional principal amount, which is usually not exchanged between counterparties. Consequently, swaps can be used to create unfunded exposures to an underlying asset, since counterparties can earn the profit or loss from movements in price without having to post the notional amount in cash or collateral. Swaps can be used to hedge certain risks such as interest rate risk, or to speculate on changes in the expected direction of underlying prices.

Investment system 14 is also shown coupled to an insurance provider system 16 for providing insurance instruments to insure securities purchased from security provider 18 by investment system 14. Preferably, in this illustrated embodiment of the present invention, insurance provider system 16 is an investment bank or like institution that offers derivative products that protect the occurrence of negative valuation of acquired securities over a period of time. In the illustrated embodiment of the invention, such derivative products will be made with reference to OTC derivative products which are customized OTC put options which are not publicly available, otherwise known as OTC derivatives, as will be discussed further below. However, such derivative products are not to be understood to be limited thereto but may encompass other type of derivative products such as swaptions and exchange traded derivative products.

It is to be appreciated, although not shown, that each aforesaid system (investment system 14, insurance provider system 16 and security provider system 18) in the illustrated embodiment of FIG. 1, includes a computer system which may include peripheral devices such as a keyboard, a speaker, a display, a printer, a modem, a network card, and any other suitable device. Each computer system may be a personal computer having a microprocessor, memory, a hard drive having stored thereon an operating system and other software and firmware, and input devices such as a mouse, a keyboard, a CD-ROM drive, or a floppy disk drive. The computer system may also be interoperable with a PDA type device, a cell phone, or other hand held type computer device that allows for receiving and transmitting information or data. Further, each computer system may include or be interoperable with a server that may take on various known forms for a server including a personal computer, a computer system, or a network. Each server may be interoperable with the Internet, a Local Area Network (LAN) or other closed network system.

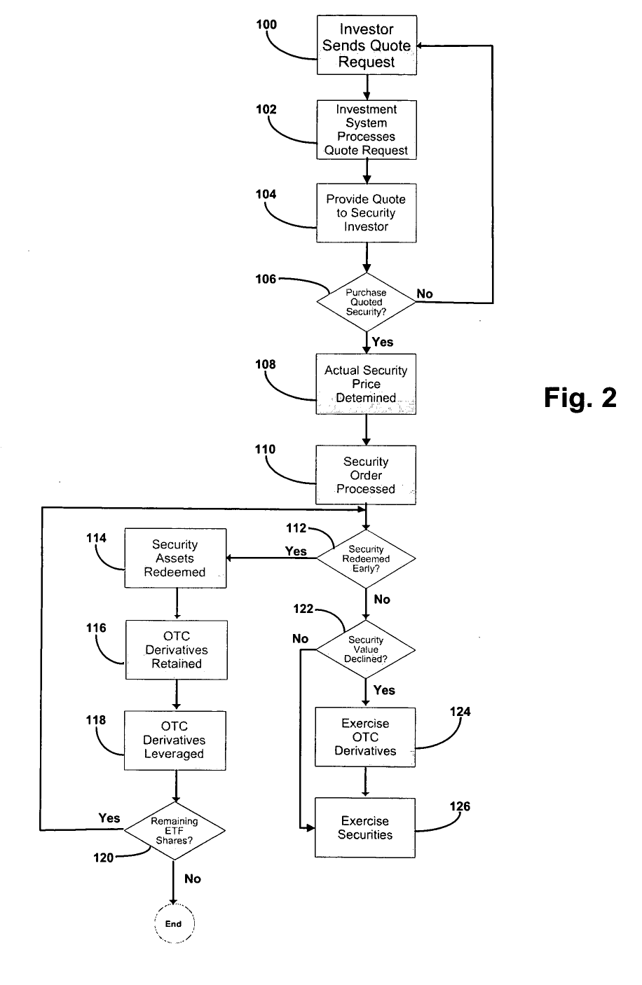

With reference now to FIG. 2, (and with continuing reference to FIG. 1), the use of system 10 for providing ETF securities having matched insurance instruments will now be discussed. Starting at step 100, a security investor 12 communicates with investment system 14 to provide a quote for purchasing an Insured ETF security share from security investment system 14, with security investment system interacting with security provider system 18 and insurance provider 16.

Investment system 14 is shown coupled to an insurance provider system 16 and a security provider 18. As will be discussed further below, security provider 18 is operative to issue shares of ETF securities purchased by investment system 14, preferably on behalf of the security investor 12. Insurer provider system 16 is operative to issue customized underwritten insurance instruments that protect the shares of the ETF securities purchased from security provider 18. Therefore, if the value or the price of the ETF security shares decrease over time, the security investor 12 will be protected against any such decrease in their value. In particular, if at the end of the contract term for the insurance instrument (as discussed further below) for the purchased ETF security, the price per share of the purchased ETF security is below the pre-determined protected price or value, the insurance instrument will pay the difference between the protected price of the ETF security and the value of the share price of the ETF security on the day that the insurance instrument matures. For instance, if an ETF security is purchased by a security investor 12 for $100 per share then each purchased share of the ETF security is protected against any decline in the price from $100 at the contract maturity date for the insurance instrument protecting each purchased share of the ETF security. Thus, if each ETF security share was purchased by a security investor 12 on Jun. 1, 2009 (the contract purchase date) at $100 per share with a contract term maturity date of three years (e.g., Jun. 1, 2012) and if the price of the insured ETF security shares decline below the protected price of $100 then the insurance instrument issued by insurer provider system 16 will pay investment system 14 the amount that the ETF security shares have declined whereafter investment system 14 will then pay this amount to investor 12. By way of example, if the ETF security price is $80 per share on the contract term maturity date (e.g., Jun. 1, 2012), upon exercise, the insurance instrument will pay the security investor 12 $20 per ETF security share. As can be appreciated, if the share price per ETF security were to increase to $150 per ETF security share, then insurance instrument would not be exercised and would expire.

With continuing reference now to step 100 of FIG. 2, a security investor 12 communicates with investment system 14 to request a quote for purchasing insured ETF securities for a notional amount. It is to be appreciated that a “notional amount” for a financial instrument (e.g., ETF) is the nominal or face amount that is used to calculate payments made on that instrument (shares of an ETF security). This amount generally does not change hands and is thus referred to as “notional”.

Next, the computer system of investment system 14 estimates the number of shares an ETF security and Over-The-Counter Derivatives (OTC) put option contracts that can be purchased to meet the investor's 12 order, and fully insure the acquired shares, at the quoted notional amount (step 102). For purposes of this embodiment of the present invention, OTC shall be understood to mean a direct interaction between two parties (e.g., investment system 14 and insurance provider system 16) without an intermediary.

With regards to the amount of OTC put option contracts that are needed, the investment system 14 may use various methods for determining or calculating a price to be charged for the OTC put options corresponding to the shares of the ETF security to be purchased. For instance, a risk charge or a net single charge is determined, which risk charge may be based on such factors as the protected amount, the term of coverage, and the current price of the security to be protected. Once the risk charge is determined, an expense and profit load is then determined, and the risk charge and the expense and profit load are added together to arrive at a total gross charge. The total gross charge is the price or amount an investor will pay to protect a security. Typically, the pricing methodology involves determining a risk charge or a net single charge and an expense and profit load added to the net single charge. The calculation for determining a risk charge may be based on the assumption that the underlying risk in a financial product for protecting a security which protects against a decrease in the value of the protected security during a term of coverage is equivalent to the price of a put option on that ETF security with a strike price equal to the protected amount and a term of coverage equal to the time to expiry for the option. The basic Black-Scholes options pricing formula can be used to price European style options with no provision for dividends. Generally, dividends have only a small impact on the price of an option, and in the calculations performed herein dividends are ignored. However, it is possible and contemplated to include dividends when performing the calculation to determine a price to be charged for purchasing the financial product. Further, it is also contemplated to employ other options pricing formulas or algorithms to determine a risk charge such as Binomial Pricing, Flexible Binomial Pricing, Finite Difference, and Analytic Approximation. Preferably, in the illustrated embodiment of the present invention, the OTC derivative shall preferably consist of put options, and particularly European and/or Bermudan put options which typically have a one day exercise window to minimize fee transaction costs to the security investor 12.

Next, the investment system 14 then indicates to the security investor 12 an estimate of the number of shares of an ETF security (each having a corresponding OTC derivative put option contract to insure each aforesaid ETF index fund) that could be purchased to meet security investor 12's ETF security quote at the stated nominal amount (step 104). It is to be appreciated that this estimate shall preferably include the “contract term” for the aforesaid OTC derivative put option contracts. The “contract term” is to be defined by the investment system 14 as the duration of time during which security investor 12 needs to retain the insured ETF securities in order to be able to exercise the OTC derivative contracts (if necessary) on a contract term maturity date, as discussed further below.

Next, the security investor 12 interacts with the computer system of investment system 14 to decide whether or not to purchase the aforesaid insured ETF security shares at the quoted price (step 106). If no, then the process repeats with step 100 again wherein the security investor 12 may make another quote request. If yes, then the computer system of the investment system 14 determines the actual market price for each requested ETF security share and the “fee” for purchasing and insuring each ETF security share (step 108). It is to be appreciated that this “fee” includes the cost of purchasing the OTC derivative put contracts from an insurance provider system 16 preferably plus administrative and other related costs incurred by the investment system 14 for processing this transaction. That is, and based upon the investor 12's initial quote request (step 100), investment system 14 calculates the actual market price for each ETF security share correlating to the investor 12's notional amount which is to be protected for the contract term (e.g, three years) during which contract term the each purchased share of the ETF security will be protected against a loss in the purchase price or the value of ETF security via OTC derivative put contracts.

The investment system 14 then processes the order for the aforesaid requested ETF security shares by placing an order on that date (e.g., Jun. 1, 2009) for the ETF index securities shares with security provider 18 based upon the following formula: amount of purchased ETF index securities shares=(Notional Amount−Fee)/ETF index price (step 110). Thereafter, from proceeds included in the Fee amount, the investment system 14 also brokers with the insurance provider system 16 to obtain the OTC derivatives that are to protect each purchased ETF security share during the contract term. Afterwards, the investment system 14 preferably sends an order confirmation to the investor 12 indicating the number of ETF security shares purchased and the cost per share. Thus investment system essentially bundles or packages the purchased ETF security share with the acquired OTC derivative to provide an “insured security.”

During the contract term (e.g., Jun. 1, 2009 to Jun. 1, 2012), a determination is made by investment system 14 as to whether the security investor 12 desires to redeem the insured index security shares, or a portion thereof, prior to the contract term maturation date (e.g., Jun. 1, 2012) (step 112). It is to be appreciated that investment system 14 may negotiate with security investor 12 to either allow either full or partial redemptions prior to the maturation date of the contract term, as discussed further below.

If yes, then the purchased insured security shares, or the requested share portion thereof, is sold by investment system 14, preferably for market value, on behalf of the security investor 12. The proceeds thereof are then transferred to the security investor 12 minus any early termination fees imposed by investment system 14. It is noted that since security investor 12 redeemed the purchased ETF Index Securities prior to the maturation date of the contract term (Jun. 1, 2012), then the correlating purchased OTC derivatives can not be exercised since they have not yet matured. Thus, if the share price of the purchased insured security is less then the price paid on the purchase date (Jun. 1, 2009), then the early redeemed shares of the insured security are not protected against such a decline in value. Any increase in value is of course passed on to the security investor 12.

With regards to the OTC derivatives that were purchased on the contract purchase date (Jun. 1, 2009) which have not yet matured, the investment system 14 shall retain ownership of these OTC derivatives wherein the security investor 12 has forfeited any ownership or other rights thereto via the aforesaid early redemption of the aforesaid insured security shares. The investment system 14 may thereafter leverage these non-matured OTC derivatives as it see fits (e.g., sell back to insurance provider system 16) (step 118). Alternatively, the investment system 14 may retain these non-matured OTC derivatives and exercise them for value upon its contract maturity date (e.g., Jun. 1, 2012) if the OTC derivatives have positive value. It is to be appreciated that even though the shares of the insured securities may have been redeemed prior to the contract maturity date, the underlying OTC derivatives nevertheless remain viable instruments with their value being unaffected.

A determination is then made as to whether there are any remaining purchased insured security shares that were not exercised early, that is, prior to the maturity date of the contract term (e.g., Jun. 1, 2012) (step 120). If yes, then the process returns to step 112.

Returning to step 112, if a determination is made that the purchased insured security shares, or a portion thereof, have not been redeemed prior to the term date of the contract (Jun. 1, 2012), then on the contract maturity term date (Jun. 1, 2012), the investment system 14 preferably determines if the protected price per share for the purchased ETF security on the contract date (Jun. 1, 2009) is greater than the market value per share of the purchased ETF security on the contract term maturity date (Jun. 1, 2012) (step 122).

If it is determined that the market value per share of the ETF security is greater than the protected price per share on the contract purchase date (Jun. 1, 2009), then the OTC derivatives expire with no value. Thus, the security investor 14 required no exercise of insurance since the value of the purchased ETF security shares increased over the contract term.

However, if it is determined in step 122 that the market value per share of the purchased ETF security is less than the protected price per share on the contract purchase date (Jun. 1, 2009), then the investment system 14 redeems the OTC derivatives with the insurance provider system 16 wherein the redemption price is equal to the difference in value between the protected price per share purchased of the ETF security on the contract purchase date (Jun. 1, 2009) and the market value on the contract term date (Jun. 1, 2012) (step 124). By way of example, if the security investor 12 purchased the insured security on the contract purchase date (Jun. 1, 2009) having a contract term of three years (Jun. 1, 2012) with a protected price of $70 (via the acquired OTC derivative) and the actual price of each share of the insured security is at $60 on the term date then the security investment system will pay out a benefit of $10 per share for the purchased insured security through the exercise of the OTC derivatives. Thus, the paid insurance amount is the difference between the protected price and the market price of the ETF security on the date of termination of the OTC derivative.

After the aforesaid term date, the security investor 12 may elect to redeem the insured security shares for value or the security investor 12, may elect to continue to hold the insured security shares, preferably on the belief it will increase in value over time. It is noted that if the security investor 12 does elect to retain the ETF security shares contained in the insured security, the security investor 12 does so at his/her own risk wherein if it declines in value, no insurance is provided to protect such negation valuation, as described above.

It is also possible and contemplated that at the expiration of the term of the OTC derivative the security investor 12 may purchase another insured Security from the investment system 14 to protect the price of the retained ETF security shares preferably for another contract term period. For example, if at the end of the term of the insured security the market price per share of the purchased ETF security is the protected price or greater than the protected price, then no claim may be made and the user may purchase another insured security to protect against a decline or a reduction in the price per share of the retained insured security for another negotiated contract term. In this manner, the security investment system 14 may purchase an OTC derivative product in serial fashion to protect the value of the ETF security shares for the negotiated contract term.

It is also possible and contemplated that the security investor may desire to protect only a portion of the value or the price of the ETF security shares that are purchased. For example, the security investor 12 may only want to protect half of it's position during a contract term for the purchased ETF security shares.

While the invention has been described in connection with a preferred embodiment for a system and method for protecting a security, it is not intended to limit the scope of the invention to the particular system or method set forth and discussed. It is to be understood and appreciated that to those skilled in the art, many changes, modifications, variations, and other uses and applications of the subject system and method for protecting a security are possible and contemplated. All changes, modifications, variations, and other uses and applications which do not depart from the spirit and scope of the invention are deemed to be covered by the invention, which is limited only by the claims which follow.

What is claimed is:

1. A system for providing protected securities, said system comprising an investment system electronically coupled to a security provider system operative to issue securities and to an insurance provider system operative to issue insurance instruments that protect securities issued from said security provider over a prescribed period of time wherein said investment system is operative to acquire said insurance instruments from said insurance provider system and said securities from said security provider system so as to package said insurance instruments with said securities to provide a protected security such that a value of said protected security is protected over a period of time.

2. A system as recited in claim 1 wherein said security provider system is operative to issue securities selected from the group consisting of Exchange Traded Fund (ETF) shares, mutual fund shares, swaps, total return swaps and exchange traded notes.

3. A system as recited in claim 1 wherein said insurance provider system is operative to issue Over-The-Counter derivative products that protect against a negative decline in value of said protected security over a specified period of time.

4. A system as recited in claim 3 wherein said OTC derivative products issued from said insurance system are put option contracts.

5. A system as recited in claim 3 wherein said OTC derivative products issued from said insurance system are swaptions.

6. A system as recited in claim 4 wherein said put option contracts are selected from the group consisting of american put options, european put options and bermudan put options.

7. A system as recited in claim 1 wherein said insurance provider system is operative to issue exchange traded derivative products that protect against a negative decline in value of said protected security over a specified period of time.

8. A system as recited in claim 7 wherein said exchange traded derivative products issued from said insurance system are put option contracts.

9. A system as recited in claim 8 wherein said put option contracts are selected from the group consisting of american put options and european put options.

10. A method for issuing an insured security from an investment system, said method comprising the steps of:
acquiring in said security provider system a predetermined amount of shares of a security with each said share being of a predetermined value;
acquiring from a insurance provider a predetermined amount of derivative products having a contract time period and a maturity date; and
packaging said acquired securities shares with said acquired derivative products to provide said insured security having a predetermined price and a predetermined maturity date.

11. A method for issuing an insured security as recited in claim 10 wherein said acquired derivative products are selected from the group consisting of Over-The-Counter (OTC) derivative products, exchange traded derivative products, swaps and swaption contracts.

12. A method for issuing an insured security as recited in claim 10 further including the steps of:
determining if an investor exercises at least a portion of said insured securities prior to expiration of said maturity date;
exercising for value said at least a portion of said insured securities; and
retaining in said investment system all of said derivative products.

13. A method for issuing an insured security as recited in claim 10 further including the steps of:
exercising for value in said investment system said derivative products at expiration of said maturity date if there is a negative change in value of said insured securities; and
providing said exercised value from said investment system to a said investor.

14. A method for issuing an insured security as recited in claim 10 wherein said acquired security is selected from the group consisting of Exchange Traded Fund (ETF) shares, mutual fund shares, swaps and exchange traded notes.

15. A method for issuing an insured security as recited in claim 10 wherein said derivatives are put option contracts.

16. A method for issuing an insured security as recited in claim 10 wherein said derivatives are swaption contracts.

17. A method for issuing an insured security as recited in claim 15 wherein said put option contracts are selected from the group consisting of american put option contracts, european put option contracts and bermudan put option contracts.

18. A method for issuing an insured security from an investment system, said method comprising the steps of;
acquiring in said security provider system a predetermined amount of shares of a security with each said share being of a predetermined value;
acquiring from a insurance provider a predetermined amount of derivative products having a contract time period and a maturity date;
packaging said acquired securities shares with said acquired derivative products to provide said insured security having a predetermined price and a predetermined maturity date;
determining if an investor exercises at least a portion of said insured securities prior to expiration of said maturity date;
exercising for value said at least a portion of said insured securities if it is determined an investor exercised at least a portion of said insured securities prior to expiration of said predetermined period of time maturity date;
retaining in said investment system all of said derivative products if it is determined an investor exercised at least a portion of said insured securities prior to expiration of said maturity date;
exercising for value in said investment system said derivative products at expiration of said maturity date; and
providing said exercised value from said investment system to said investor to compensate said investor for a negative change in value for said at least a portion of said insured securities not exercised prior to expiration of said maturity date.

19. A method for issuing an insured security as recited in claim 18 wherein said acquired security is from the group consisting of Exchange Traded Fund (ETF) shares, mutual fund shares, swaps, and exchange traded notes.

20. A method for issuing an insured security as recited in claim 18 wherein said acquired derivative products are selected from the group consisting of Over-The-Counter (OTC) derivative products, exchange traded derivative products, swaps and swaption contracts.
